(19) United States
(12) Patent Application Publication
(10) Pub. No.: US 2018/0318986 A1
(43) Pub. Date: Nov. 8, 2018

(54) Ratchet Wrench

(71) Applicant: Hengjian Weng, Yangzhou (CN)

(72) Inventor: Hengjian Weng, Yangzhou (CN)

(21) Appl. No.: 15/584,876

(22) Filed: May 2, 2017

(51) Int. Cl. B25B 13/46; B25B 23/02

(52) U.S. Cl. CPC B25B 13/462; B25B 23/14; B25B 23/02

(57) ABSTRACT

A ratchet wrench with a crescent groove housing a ratchet-pawl mechanism. The ratchet-pawl mechanism has a ratchet-pawl, a spring and a spring seat with a notch. The crescent groove allows for easy access for assembling and removing the ratchet-pawl mechanism. The new structure renders reduced manufacturing and repairing cost.

### DESCRIPTION OF RELATED ART

The present application relates to a wrench, more particularly, to a ratchet wrench that is used for tightening and loosening nuts or bolts from locations that are hard to reach.

Note that the points discussed below may reflect the hindsight gained from the disclosed inventions, and are not necessarily admitted to be prior art.

A wrench is a tool used to provide grip and torque in order to turn, or to keep from turning, objects such as nuts and bolts. Common types of wrenches used include open-end wrench and box-end wrench. There are many other types of wrenches, for example, the tube wrench, ratcheting box wrench, flex-head socket wrench, spanner wrench, hammer wrench, adjustable wrench, monkey wrench, pipe wrench, socket wrench, breaker bar, crowfoot wrench, speed wrench, torque wrench, allen wrench, bristol wrench, torx wrench, alligator wrench, cone wrench, die wrench, drum wrench, spark plug wrench, fire hydrant wrench, curb key, etc.

A ratchet wrench is a type of wrench that contains a ratchet mechanism in which allows a socket to be turned without removing the wrench from the nut or bolt when cycling the handle backwards and forwards. The ratchet usually contains a small gear or a rack of teeth with a spring-loaded finger known as the pawl which engages the teeth. The pawl is necessary in order to prevent the backwards motion of the gear so that the bolt or nut can be held in place while the handle of the wrench is moved back so another round of forward motion can occur in order to tighten the bolt or nut further without having to remove the wrench. This mechanism, known as the backlash, provides a convenient way for mechanics to work on cars within a tight location and with an improved ease on the human arm. Also, the ratchet wrench is utilized in workshops that focus on building or servicing machine tools. They can be used for home improvement tasks as well.

There are many prior patents that are involved in the art of developing a ratchet wrench. The design of ratchet mechanism has been the center for improvement. For example, U.S. Pat. No. 8661945 B1 to ElDessouky describes a complicated clamping mechanism to hold the ratchet in place. U.S. Pat. No. 9027444 B2 to Chang designs a magnetic member and a screw nut and multiple limiters within the wrench head to allow for the ratchet to rotate. U.S. Pat. No. 9032845 B2 to Lin constructs a ratchet wrench which comprises of multiple recesses for the ratchet, the pawl and the rotatable unit within each recess. The structure is cumbersome to assemble and to repair.

The conventional ratchet wrenches still comprise many different parts and units which would require high manufacturing cost as well as high replacement or repair cost. Improved designs are still needed.

### SUMMARY

The present application discloses a new ratchet wrench that is easy to manufacture and to repair.

In one embodiment, a ratchet wrench comprises of a wrench head, a ratchet gear wheel and a ratchet-pawl unit wherein said ratchet-pawl unit is configured with matching teeth with the ratchet gear wheel to withhold the ratchet gear wheel within the wrench head.

In one embodiment, a wrench head comprises a receiving chamber having a “crescent groove” configured to mount a ratchet-pawl unit wherein the crescent groove is sufficiently sized and shaped to hold the ratchet-pawl unit within the receiving chamber.

In another embodiment, the ratchet-pawl unit comprises a pawl, a spring and spring-seat structure wherein the spring serves as a connection mechanism between the pawl and the spring-seat, and the pawl and the spring-seat are configured to match the crescent groove so that the pawl is able to hold and release the ratchet gear wheel from the wheel teeth so that the ratchet wheel can rotate.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 shows a prior art ratchet wrench.

FIG. 2 shows an elevated view of an example ratchet wrench head in accordance with this application.

FIG. 3A shows a perspective view of an example receiving chamber of an example ratchet wrench head in accordance with this application.

FIG. 3B shows a cross-section view of an example receiving chamber of an example ratchet wrench head in accordance with this application.

FIG. 4A shows an expanded view of an example ratchet-pawl unit in accordance with this application.

FIG. 4B shows an example ratchet-pawl unit assembly in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the following figures illustrate the general manner of construction, and description and details of well-known features and techniques that may be omitted to avoid unnecessarily obscuring the invention. Additionally, elements in the figures are not necessarily drawn to scale; some areas or elements may be expanded to help improve understanding of the embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The term “ratchet wrench” refers to a mechanical tool having a wrench handle and a wrench head capable of receiving a ratcheting mechanism attached to a socket wherein the socket is used to tighten or loosen a bolt or a nut. The ratcheting mechanism allows the bolt or nut to be rapidly tightened or loosened in small increments without disconnecting the tool from the fastener.

The term “socket” refers to a structure that is capable of fitting onto a type of bolt or nut to allow for a wrench to tighten or loosen a bolt or a nut. The socket structure may be either independent of a wrench handle or integrally built with the wrench handle.

The term “ratcheting mechanism” refers to a gear-like rotatory unit that is either independently built or integrally built together with a socket structure of a ratchet wrench.

The term “ratchet head” refers to a structure of a ratchet wrench that includes a receiving chamber for receiving and mounting a socket structure. A ratchet head may be independent of a wrench head or an integrally built to a wrench head.

The term “crescent groove” refers to a groove structure configured within a ratchet head wherein the groove structure forms an empty crescent space similar to the shape of a crescent moon.

The term “ratchet-pawl” refers to a structure that interacts with the ratcheting rotary unit to either lock or release the ratcheting rotary unit for not-rotating or free rotating motions.

The term “spring seat” refers to a structure that holds a spring for mounting the ratchet-pawl inside the crescent groove so that the ratchet-pawl is capable of engaging or disengaging the ratcheting mechanism.

A ratchet wrench is a hand tool in which generally metal handle is attached to a ratcheting mechanism, which attaches to a socket, which in turn fits onto a type of bolt or nut. Pulled or pushed in one direction, the ratchet loosens or tightens the bolt or nut attached to the socket. Turned the other direction, the ratchet does not turn the socket but allows the ratchet handle to be re-positioned for another turn while staying attached to the bolt or nut. This ratcheting action allows the fastener to be rapidly tightened or loosened in small increments without disconnecting the tool from the fastener. A switch mechanism is built into the ratchet head that allows the user to apply the ratcheting action in either direction, as needed, to tighten or loosen a fastener.

Independently built sockets may be driven by being attached to the driving tool via a male/female square connection fitting. Standard sizes of square drives around the world include ¼″, ⅜″, ½″, ¾″, 1″, 1-½″, 2-½″ and 3-½″ square drive sizes along with some lesser used drivers such as ⅝″ square drive, and spline drives specified in ANSI specifications. This wide range of square drive sizes provides for a wide variety of socket types and sizes to suit small to very large nuts and bolts. Some square drivers have a through hole to attach the socket to the driver such as a retaining ring with 0-ring and pin type, or single piece molded retaining rings, a locking pin, or friction ball. Some common hand ratchets employ a quick release button on their top for quick socket release of smaller sockets. The tool chosen to drive the socket wrench ultimately supplies the mechanical advantage needed by the user to provide the torque needed to loosen or tighten the fastener as may be required. Larger drivers are typically used with higher torque, while smaller drivers are used for convenience in smaller low torque applications. Very large sockets and drivers are typically powered by hydraulics to achieve torque.

A socket is typically a cylinder which has a female six- or twelve-point recessed opening sized to fit over the common male hexagonal head of a bolt or nut fastener. The opposite end of the socket wrench may have square recess to accept the socket wrench's drive size. Male drivers are also produced for use with socket head cap screws.

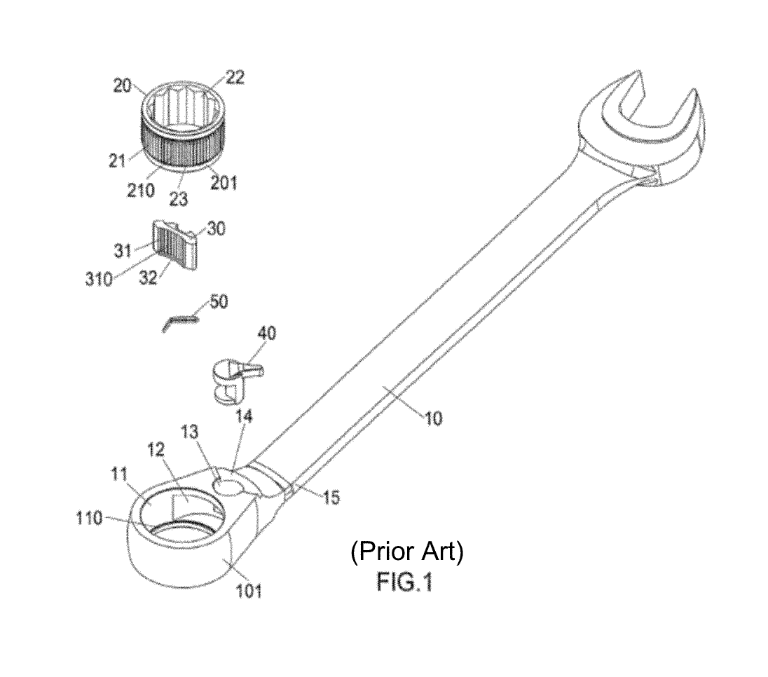

For example, in reference to FIG. 1, a prior art ratchet wrench includes a wrench head 101, wrench handle 10, a rotary gear 20 which is constructed with a rotary wheel with teeth structure 21, 23 and 210. Within gear 20 is integrally constructed with a polygonal socket 22. The most common socket shape is hexagonal, or more commonly referred to as “6-point.” A ratchet pawl 30 with matching teeth 31, 32 and 310 to gear 20 are part of the switch mechanism that also includes a pin 50 and a switch 40. A recess groove 12 and hole 13 are built on the wrench head 101 for receiving and mounting ratcheting mechanism and socket that includes gear 20, switching set 30 and 50 and 40.

However, the independent and separate switching mechanisms 50 and 40 need additional manufacturing steps which increase manufacturing cost, assembly cost and cost for repairs. An improved structure of a socket head for a ratchet wrench is hereby described below.

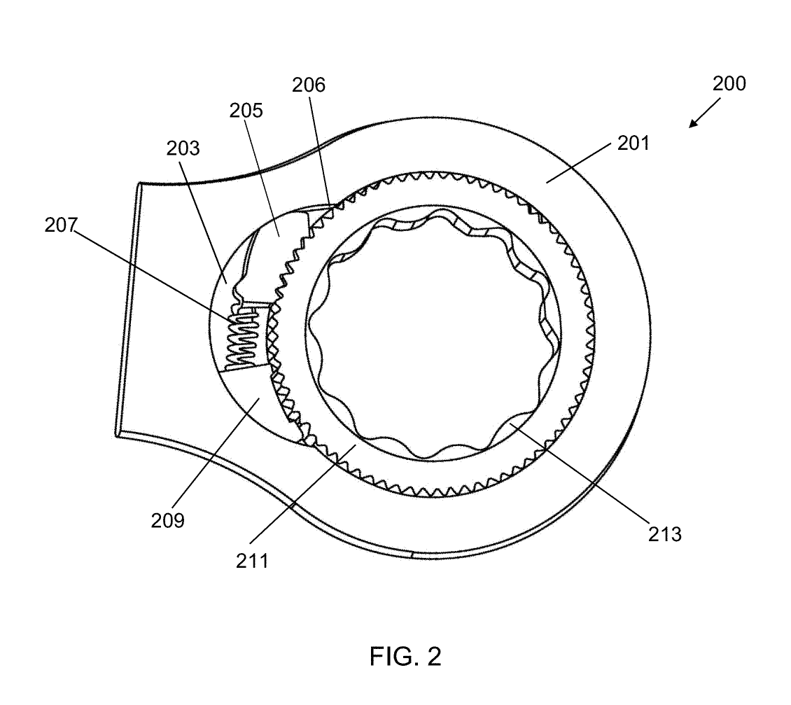

In reference to FIG. 2, a socket head structure 200 is shown. For simplicity, the figured socket head illustrated is an integral piece of the wrench head. However the socket head can also be constructed independent of a wrench head and wrench handle and that can be mounted to a separate wrench head and wrench handle. Socket head 200 includes a receiving chamber 201 in which houses the ratchet-pawl transmission unit that includes a ratchet rotary unit 211 that contains an integrally constructed socket structure 213, a ratchet-pawl 205, a spring 207 and a spring seat 209, where receiving chamber 201 is constructed with a crescent groove 203 for housing the ratchet-pawl assembly. Spring seat 209 and ratchet-pawl 205 are configured with a surface that matches the curvature of the crescent shape of groove 203. In use, the narrowed ends of crescent groove 203 will stop spring seat 209 and ratchet-pawl 205 from moving further once they are pulled to the ends by the toque force while the middle section enlarged space will allow spring seat 209 and ratchet-pawl 205 to move to be disengaged with the gear teeth of rotary unit 211 when pulled by the connecting spring 207, but then at relaxed position can ratchet-pawl 205 re-engage with the gear teeth of rotary unit 211.

In use, at the relaxed position in the middle section of crescent groove 203, ratchet-pawl 205 engages with the gear teeth of rotary unit 211, when rotary unit 211 rotates clockwise, ratchet-pawl 205 will be pulled towards the narrowing end 206 of crescent groove 203 to the point that ratchet-pawl 205 cannot move further, rendering the engaged rotary unit 211 unable to rotate further. Once rotary unit 211 is unable to rotate clockwise direction, continued rotating torque force from the wrench handle and wrench head will thus be transferred onto the nut or bolt that is inside socket 213 space to turn the nut to the point when there is no further space for the wrench handle to turn clockwise. The wrench finishes one round of rotating job. Then the wrench head and wrench handle can move anticlockwise without detaching from the socket head 200, and the rotary unit 211 will pull the engaged ratchet-pawl 205 to move toward the center section of crescent groove 203, the enlarged space at the center section allows stressed spring 207 to pull ratchet-pawl 205 towards the middle and temporarily disengaging from rotary unit 211, causing the torque force applied on the wrench head and its receiving chamber 201 disengaged from interacting with the rotating rotary unit 211 and the socket 213. The wrench handle and head can thus rotates anticlockwise to re-position while the rotating rotary unit 211 and the socket 213 stays still and attached to the bolt or nut inside socket 213.

Once ratchet-pawl 205 is pulled by spring 207 and moves to the middle section of the crescent groove 203, spring 207 relaxes, and ratchet-pawl 205 in relaxed position, with the assistance spring seat 209, is in the right position to re-engage with the gear teeth of rotary unit 211, which stops the wrench to further re-position by rotating anticlockwise, and a user can then start to a second round of rotating clockwise to apply the torque force to the nut or bolt inside socket 213. Spring seat 209 provides a stabilization structure to spring 207 and guides the move of ratchet-pawl 205 so that when ratchet-pawl 205 moves towards the end of crescent groove 203, there is enough stress within spring 207 that can pull ratchet-pawl 205 to the middle section to disengage and to re-engage with gear teeth of rotary unit 211.

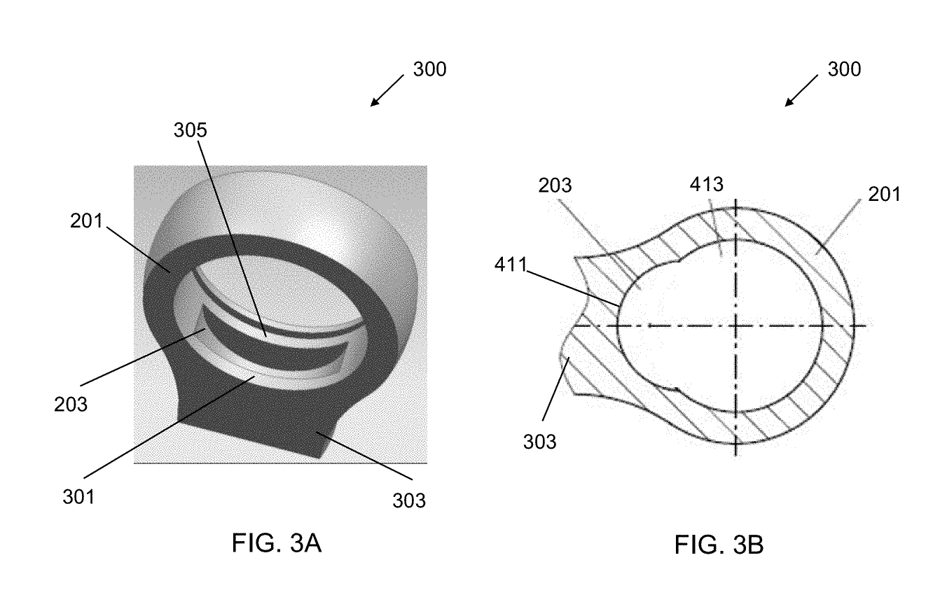

In reference to FIG. 3A and 3B, an example receiving chamber 300 is shown, in which receiving chamber 300 has a cylindrical shell body 201 that is capable of housing a rotary unit and a socket; and at one end the cylindrical shell body may be extended into a wrench handle 303. Alternatively, receiving chamber 201 may be independently built and fixedly mounted to a wrench head that is connected with a wrench handle. On the receiving cylindrical shell body 201, a crescent groove 203 is carved into the wall at one side of the shell body (FIG. 3B), preferably at the side of extension to the wrench handle that provides sufficient size for carving a crescent groove into. Crescent groove 203 is formed by two side walls 301 and 305 and a semi-circular shaped bottom side 411 that are integral part of the cylindrical shell body 201. The cross-section of the receiving chamber 300 thus forms two inter-crossed circular spaces 413 and 203 which would respectively house a ratchet rotary gear unit and bolt socket and a ratchet-pawl assembly so that the ratchet-pawl assembly housed in the middle of space 203 comes into contact with the rotary gear unit housed in space 413.

Preferably all the different parts are made of heavy hard metal or stainless steel for providing sufficient durability and resilience.

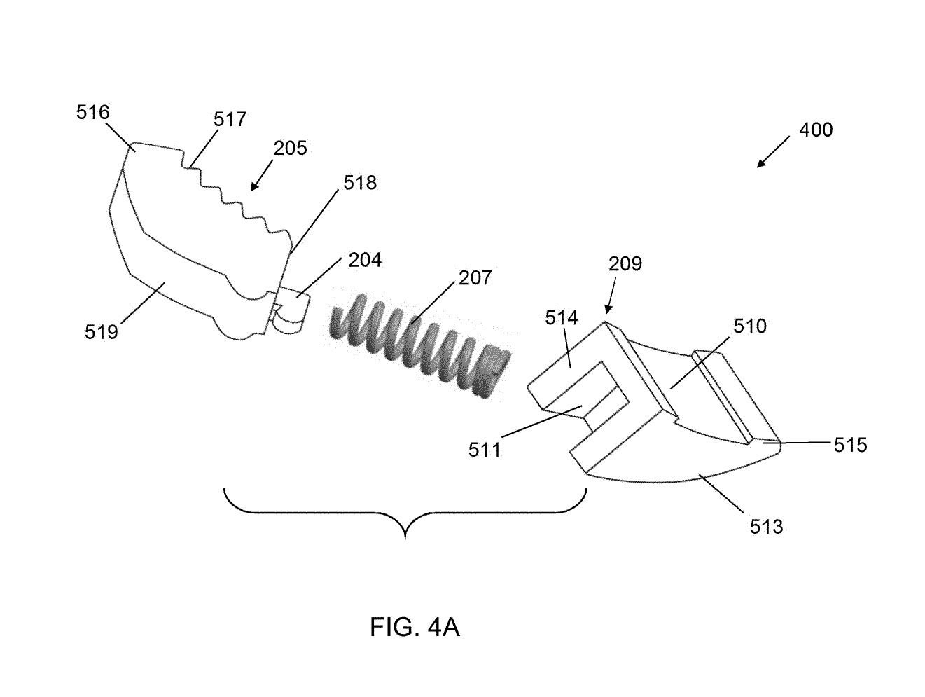

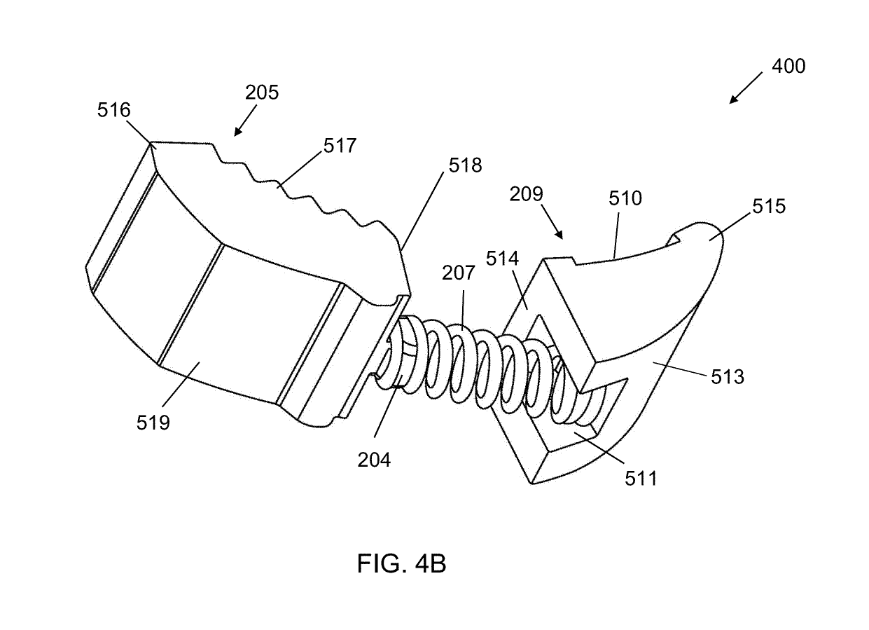

In reference to FIG. 4A and 4B, elevated views of an example ratchet-pawl assembly 400 are shown. The ratchet-pawl assembly 400 comprises ratchet-pawl 205, spring 207 and spring-seat 209. Ratchet-pawl 205 comprises an elongated body in the shape of a first with a sharper end 516 and a wider end 518, a teethed side 517 and a curved side 519. Teethed side 517 provides a surface that are slightly curved in order to interact with the gear teeth of a ratchet rotary unit while the curved side 519 provides a matching shape to a crescent groove of a receiving chamber so that ratchet-pawl 205 can slide down the crescent groove to be disengaged from the gear teeth of a ratchet rotary unit. The sharper end 516 is constructed to fit with the crescent groove's angled end and the wider end 518 is constructed to interact with spring 207 which in turn interacts with spring-seat 209. A small handle 204 may be configured on wider end 518 for mounting spring 207. Spring seat 209 may similarly comprises an elongated body in the shape of a wedge with a sharper end 515 and a wider end 514, a slightly curved side 510 for facing and fitting a ratchet rotary unit and a greater curved side 513 for fitting with the curvature of a crescent groove. On the wider end 514 may be constructed a notch 511 for holding and guiding the movement of spring 207. FIG. 4B shows an assembled ratchet-pawl assembly where ratchet-pawl 205 is fixedly linked to spring seat 209 by spring 207. Notch 511 is constructed to render have an opening on spring seat 209 so that spring 204 can easily slide into the notch for assembling.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A ratchet wrench having a teethed ratchet rotary unit, comprising:
ratchet-pawl assembly comprises a ratchet-pawl having a teethed side, a spring, and a spring-seat, said spring being mounted between said ratchet-pawl and said spring-seat linking said ratchet-pawl and said spring-seat together, said and said teethed side of said ratchet-pawl engaging with said teethed ratchet rotary unit when said spring is relaxed.

2. The ratchet wrench of claim 1, further comprising:
a ratchet socket receiving chamber having a cylindrical shell body,
wherein said cylindrical shell body has a first cylindrical portion housing said teethed ratchet rotary unit, said cylindrical portion having an inner wall facing said teethed ratchet rotary unit, and
said cylindrical shell body has an enlarged portion, said enlarged portion having a first side wall, a second side wall and a continuous crescent-shaped bottom wall that form a crescent-shaped groove opening, said crescent-shaped bottom wall merging unto said inner wall of said cylindrical portion, said crescent groove opening has a center section and a first end and second end, said center section being farthest from said ratchet rotary unit, and both said first end and second end being closest to said teethed ratchet rotary unit, and a ratchet-pawl assembly being disposed within said crescent-shaped groove opening.

3. The ratchet wrench of claim 2, wherein said spring-seat is configured in a shape of a wedge, said spring-seat having a first side and a second side, said first side being curved to allow said teethed ratchet rotary unit to rotate, and said second side being shaped to match said said crescent-shaped bottom wall.

4. The ratchet wrench of claim 2, wherein a notch opening is configured on said spring-seat for sliding-in said spring, wherein said spring slidingly mounted into said notch opening.

5. The ratchet wrench of claim 2, wherein said ratchet-pawl is configured in fist-shaped having a an angled and and a wide-end, a handle being formed on said wide end for mounting said spring.

6. The ratchet wrench of claim 5, wherein said spring-seat is configured with an angled end and a wide end, said angled end of said ratchet-pawl is disposed towards the first end of said crescent groove and said wide-end of said ratchet-pawl is disposed toward the center section of said crescent groove, and said spring is disposed between said wide-end of ratchet-pawl and said wide end of said spring-seat.
